(19) United States
(12) Patent Application Publication
(10) Pub. No.: US 2022/0019303 A1
(43) Pub. Date: Jan. 20, 2022

(54) TOUCH SUBSTRATE, DISPLAY PANEL, AND DISPLAY DEVICE

(71) Applicant: WUHAN CHINA STAR OPTOELECTRONICS SEMICONDUCTOR DISPLAY TECHNOLOGY CO., LTD., Wuhan (CN)

(72) Inventor: Bi CHEN, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/638,136

(22) PCT Filed: Dec. 19, 2019
(86) PCT No.: PCT/CN2019/126776

§ 371 Date: Feb. 11, 2020

(30) Foreign Application Priority Data
Dec. 3, 2019 (CN) 201911221430.5

(51) Int. Cl. G06F 3/041; G06F 3/044

(52) U.S. Cl. CPC G06F 3/0412; G06F 3/0446; G06F 2203/04111; G06F 3/0448; G06F 3/04164; G06F 3/0445

(57) ABSTRACT

The present invention provides a touch substrate, a display panel, and a display device. In the present invention, a first electrode layer and a second electrode layer are arranged in two different layers, thereby avoiding a technical problem of uneven brightness in positions for connecting metal bridges, thus improving the display quality of the display panel.

This application claims priority to Chinese patent application no. 201911221430.5, entitled “Touch Substrate, Display Panel and Display Device”, filed on Dec. 3, 2019, the entire contents of which are incorporated by reference in this application.

### 1. FIELD OF DISCLOSURE

The present disclosure relates to a field of display technology and in particular, to a touch substrate, a display panel, and a display device.

### 2. DESCRIPTION OF RELATED ART

With rapid development of technology, touch panels have been extensively used in smart phones, GPS navigator systems, tablet PCs, laptops, and other electronic products due to their human-computer interaction functions. Touch sensing elements of a conventional mutual-capacitive touch panel are composed of a plurality of driving electrodes and a plurality of sensing electrodes, and the two are intersected with each other. In order to avoid electrical connection between the driving electrodes and the sensing electrodes, the driving electrode and the sensing electrode are constituted by two conductive layers. However, to form a touch sensing element by means of two conductive layers, a first insulating layer needs to be disposed between the two conductive layers to insulate them from each other. This undoubtedly is a limitation on reducing a thickness of the touch panel to further meet a trend towards thinner products. For this reason, mutual-capacitive touch sensing elements with a single-layer structure have been developed.

A conventional single-layer mutual-capacitive touch sensing element is composed of a sensing electrode and a driving electrode, and each sensing electrode is arranged corresponding to a driving electrode, so that each driving electrode and a different part of the sensing electrode constitute a sensing unit. Although the single-layer touch sensing element can reduce a thickness of a touch panel, a single-sided bridge is used in designing a touch pattern for a touch design. The driving electrodes or the sensing electrodes need to be electrically connected through metal bridges, and it is necessary to make holes in the first insulating layer and connect the driving electrodes with the metal bridges. In order to ensure good electrical connection, positions for connecting the metal bridges need to consider an alignment tolerance, so a metal width at these positions is wider than other positions, which causes a pixel to have different brightness in these positions compared to the brightness in non-bridged positions, leading to nonuniform display quality of the display panel.

### SUMMARY

The present invention provides a touch substrate, a display panel and a display device thereof. Compared to a conventional mutual-capacitive touch sensing element with a single layer structure, the present application adopts a layered structure. A first electrode layer and a second electrode layer are arranged in two different layers, thereby avoiding a conventional technical problem that nonuniform brightness occurs at positions for connecting metal bridges, thus improving display quality of the display panel.

Accordingly, in one aspect, the present application provides a touch substrate. The touch substrate comprises a touch region, wherein the touch substrate comprises a first electrode layer, a second electrode layer, and a first insulating layer, the first insulating layer is disposed between the first electrode layer and the second electrode layer, and the first electrode layer and the second electrode layer are disposed in the touch region.

The first electrode layer comprises at least two first electrodes arranged spaced apart along a first direction, the at least two first electrodes are insulated from each other, the second electrode layer comprises at least two second electrodes arranged spaced apart along a second direction, the at least two second electrodes are insulated from each other, and the first direction is unparallel to the second direction.

The first electrode comprises a plurality of first metal lines and a plurality of second metal lines, and the first metal lines and the second metal lines are intersected to form a plurality of first grid units; and/or

the second electrode comprises a plurality of third metal lines and a plurality of fourth metal lines, and the third metal lines and the fourth metal lines are intersected to form a plurality of second grid units.

A line width of the first metal line ranges from 0.1 um to 5 um, and/or a line width of the second metal line ranges from 0.1 um to 5 um, and/or a line width of the third metal line ranges from 0.1 um to 5 um, and/or a line width of the fourth metal line ranges from 0.1 um to 5 um.

Four sub-pixels are enclosed in the first grid unit, and four sub-pixels are enclosed in the second grid unit.

The first grid unit has a diamond shape or a square shape.

The first metal line comprises a plurality of bending portions.

The first electrode is a driving electrode, and the second electrode is a sensing electrode; or the first electrode is a sensing electrode, and the second electrode is a driving electrode.

The touch substrate further comprises a touch circuit, the first electrode is connected to the touch circuit through a first electrode wire, and the second electrode is connected to the touch circuit through a second electrode wire.

The touch substrate further comprises a display layer, a second insulating layer, and a third insulating layer, the second insulating layer is disposed between the first electrode layer and the display layer, and the third insulating layer is disposed over the second electrode layer.

In another aspect, the present application provides a display panel comprising a touch substrate. The touch substrate comprises a touch region, wherein the touch substrate comprises a first electrode layer, a second electrode layer, and a first insulating layer, the first insulating layer is disposed between the first electrode layer and the second electrode layer, and the first electrode layer and the second electrode layer are disposed in the touch region.

The display panel is a liquid crystal display (LCD) panel or an organic light-emitting diode (OLED) display panel.

The first electrode layer comprises at least two first electrodes arranged spaced apart along a first direction, the at least two first electrodes are insulated from each other, the second electrode layer comprises at least two second electrodes arranged spaced apart along a second direction, the at least two second electrodes are insulated from each other, and the first direction is unparallel to the second direction.

The first electrode comprises a plurality of first metal lines and a plurality of second metal lines, and the first metal lines and the second metal lines are intersected to form a plurality of first grid units; and/or

the second electrode comprises a plurality of third metal lines and a plurality of fourth metal lines, and the third metal lines and the fourth metal lines are intersected to form a plurality of second grid units.

A line width of the first metal line ranges from 0.1 um to 5 um, and/or a line width of the second metal line ranges from 0.1 um to 5 um, and/or a line width of the third metal line ranges from 0.1 um to 5 um, and/or a line width of the fourth metal line ranges from 0.1 um to 5 um.

Four sub-pixels are enclosed in the first grid unit, and four sub-pixels are enclosed in the second grid unit.

The first grid unit has a diamond shape or a square shape.

The first metal wire comprises a plurality of bending portions.

The first electrode is a driving electrode, and the second electrode is a sensing electrode; or the first electrode is a sensing electrode, and the second electrode is a driving electrode.

In still another aspect, the present application provides a display device, comprising the display panel mentioned above.

### Advantages of the Present Invention

The present invention provides a touch substrate. The touch substrate comprises a touch region. The touch substrate comprises a first electrode layer, a second electrode layer, and a first insulating layer, the first insulating layer is disposed between the first electrode layer and the second electrode layer, and the first electrode layer and the second electrode layer are disposed in the touch region. Compared to a conventional mutual-capacitive touch sensing element with a single-layer structure, the present embodiment adopts a layered structure. The first electrode layer and the second electrode layer are arranged in two different layers, thereby avoiding a conventional technical problem that nonuniform brightness occurs at positions for connecting metal bridges, thus improving display quality of a display panel.

### BRIEF DESCRIPTION OF DRAWINGS

In order to more clearly illustrate the embodiments of the present disclosure or related art, figures which will be described in the embodiments are briefly introduced hereinafter. It is obvious that the figures are merely for the purposes of illustrating some embodiments of the present disclosure, and a person having ordinary skill in this field can obtain other figures according to these figures without an inventive work.

FIG. 1 is a lateral structural view illustrating a touch substrate according to one embodiment of the present invention;

FIG. 2 is a top structural view illustrating the touch substrate according to one embodiment of the present invention;

FIG. 3 is a schematic structural view illustrating a first electrode layer of the touch substrate according to one embodiment of the present invention;

FIG. 4 is a schematic structural view illustrating a second electrode layer of the touch substrate according to one embodiment of the present invention; and

FIG. 5 is a structural view illustrating the touch substrate according to another embodiment of the present invention.

### DETAILED DESCRIPTION OF EMBODIMENTS

Technical solutions of the present invention will be clearly and completely described below with reference to specific embodiments and the accompanying drawings. It is apparent that the embodiments are only some embodiments of the present invention, but not all of the embodiments. All other embodiments obtained by those skilled in the art based on the embodiments of the present invention without an inventive step are deemed to be within the protection scope of the present invention.

In the specification, it should be understood that the terms such as “central”, “longitudinal”, “lateral”, “length”, “width”, “thickness”, “above”, “below”, “front”, “rear”, “left”, “right”, “vertical”, “horizontal”, “top”, “bottom”, “inner”, and “outer”, should be construed to refer to position relationship or the orientation based on the accompanying drawings. These terms are merely for ease of description and do not alone indicate or imply that the device or element referred to must be set up or operated in a specific orientation. Thus, the present invention is not limited by the directional terms. In addition, terms such as “first” and “second” are used for purposes of description and are not intended to indicate or imply relative importance or significance or impliedly indicate quantity of the technical feature referred to. Thus, the feature defined with “first” and “second” may explicitly or implicitly indicate inclusion of one or more of this feature. In the description of the present application, “multiple” means two or more than two, unless specified otherwise.

A conventional single-layer mutual-capacitive touch sensing element is composed of a sensing electrode and a driving electrode, and each sensing electrode is disposed corresponding to a driving electrode, so that each driving electrode and a different part of the sensing electrode constitute a sensing unit. Although the single-layer touch sensing element can reduce a thickness of a touch panel, a single-sided bridge is used in designing a touch pattern for a touch design. The driving electrodes or the sensing electrodes need to be electrically connected through metal bridges, and it is necessary to make holes in the first insulating layer and connect the driving electrodes with the metal bridges. In order to ensure good electrical connection, positions for connecting the metal bridges need to consider an alignment tolerance, so a metal width at these positions is wider than a metal width at other positions, which causes a pixel to have different brightness in these positions compared to the brightness in non-bridged positions, leading to nonuniform display quality of the display panel.

Accordingly, the present invention provides a touch substrate, a display panel, and a display device. A detailed description is provided below.

First, the present invention provides a touch substrate. The touch substrate comprises a touch region. The touch substrate comprises a first electrode layer, a second electrode layer, and a first insulating layer. The first insulating layer is disposed between the first electrode layer and the second electrode layer, and the first electrode layer and the second electrode layer are disposed in the touch region.

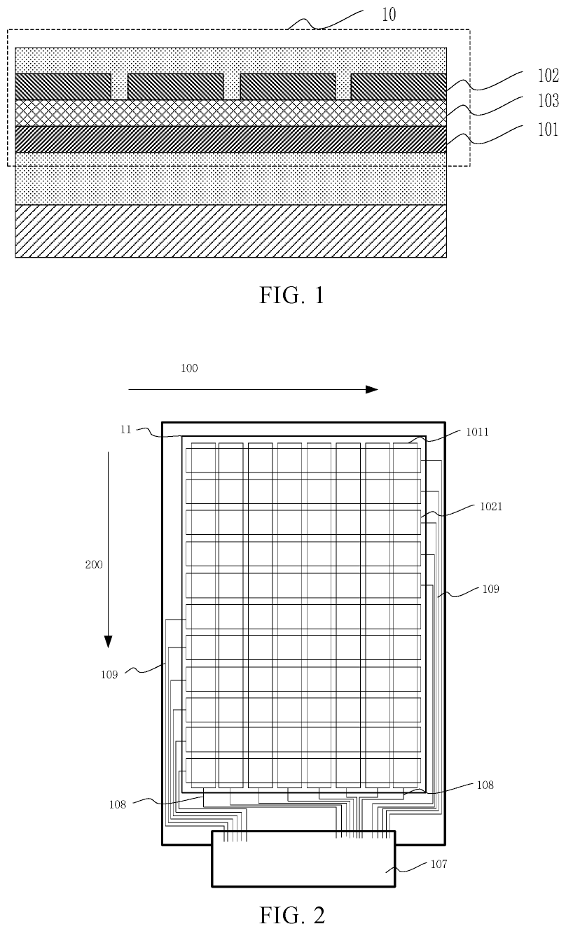

Please refer to FIGS. 1 and 2. FIG. 1 is a lateral structural view illustrating a touch substrate 10 according to one embodiment of the present invention, and FIG. 2 is a top structural view illustrating the touch substrate 10 according to one embodiment of the present invention. The touch substrate 10 comprises a touch region 11. In detail, in the touch substrate 10, the touch region 11 is a core region for providing a touch function. The touch substrate 10 comprises a first electrode layer 101, a second electrode layer 102, and a first insulating layer 103. The first insulating layer 103 is disposed between the first electrode layer 101 and the second electrode layer 102, and the first electrode layer 101 and the second electrode layer 102 are disposed in the touch region 11. The first insulating layer 103 is used to insulate the first electrode layer 101 from the second electrode layer 102 in a different layer. In detail, the first insulating layer 103 in the present embodiment is made of an organic insulating material or an insulating material. The first insulating layer 103 is made of, for example, polyester (PET); however, the present embodiment is not intended to limit the insulating material. In the present embodiment, the first electrode layer 101 and the second electrode layer 102 can be made of gold, silver, copper, lithium, sodium, potassium, magnesium, aluminum, zinc, or a combination thereof, and the first electrode layer 101 and the second electrode layer 102 can also be made of a conductive metal material such as indium tin oxide, aluminum-doped zinc oxide, antimony-doped tin oxide, and a combination thereof. For example, the first electrode layer 101 is made of an alloy of aluminum and silver. The second electrode layer 102 is made of aluminum-doped zinc oxide. The present embodiment is not intended to limit the materials of the first electrode layer 101 and the second electrode layer 102. In the present embodiment, the first electrode layer 101 and the second electrode layer 102 constitute a matrix-type projected capacitive structure.

The present invention provides the touch substrate 10. Compared to a conventional mutual-capacitive touch sensing element with a single-layer structure, the present embodiment adopts a layered structure. The first electrode layer 101 and the second electrode layer 102 are arranged in two different layers, thereby avoiding a conventional technical problem that nonuniform brightness occurs at positions for connecting metal bridges, thus improving display quality of a display panel.

According to another embodiment of the present application on the basis of the above embodiment, the first electrode layer comprises at least two first electrodes arranged spaced apart along a first direction. The at least two first electrodes are insulated from each other. The second electrode layer comprises at least two second electrodes arranged spaced apart along a second direction. The at least two second electrodes are insulated from each other, and the first direction is unparallel to the second direction.

In the present embodiment, the first electrode layer 101 comprises at least two first electrodes 1011 arranged spaced apart along a first direction 100. The at least two first electrodes 1011 are electrically insulated from each other. The second electrode layer 102 comprises at least two second electrodes 1021 arranged spaced apart along a second direction 200. The at least two second electrodes 1021 are electrically insulated from each other, and the first direction 100 is unparallel to the second direction 200. Specifically, in the touch substrate 10, a capacitor is formed in a position where the first electrode 1011 and the second electrode 1021 are intersected. In other words, the two electrodes constitute two poles of the capacitor, respectively. When a finger touches a capacitive screen, coupling between the two electrodes near a touch point is affected, thereby changing a capacitance between the two electrodes. When to detect a mutual capacitance, the electrodes in a horizontal direction send excitation signals in sequence, and all the electrodes in a vertical direction receive signals at the same time. This way, capacitance values at intersections of all the horizontal and vertical electrodes can be obtained. In other words, the capacitance values in a two-dimensional plane of the entire touch screen are obtained. According to two-dimensional capacitance change data of the touch screen, coordinates of each touch point can be calculated. Therefore, even if there are multiple touch points on the screen, the exact coordinates of each touch point can be calculated.

In the present embodiment, the first electrode layer 101 comprises at least two first electrodes 1011 arranged spaced apart along a first direction 100. The at least two first electrodes 1011 are insulated from each other. The second electrode layer 102 comprises at least two second electrodes 1021 arranged spaced apart along a second direction 200. The at least two second electrodes 1021 are insulated from each other, and the first direction 100 is unparallel to the second direction 200. The first direction 100 can be a direction from left to right and extended 45 degrees upward, and the second direction 200 can be a direction from top to bottom and extended 45 degrees to the right.

In the present embodiment, the first electrode 1011 comprises a plurality of first electrode units arranged in an array, and the first electrode units are electrically connected to each other. The second electrode 1021 comprises a plurality of second electrode units arranged in an array, and the second electrode units are electrically connected to each other.

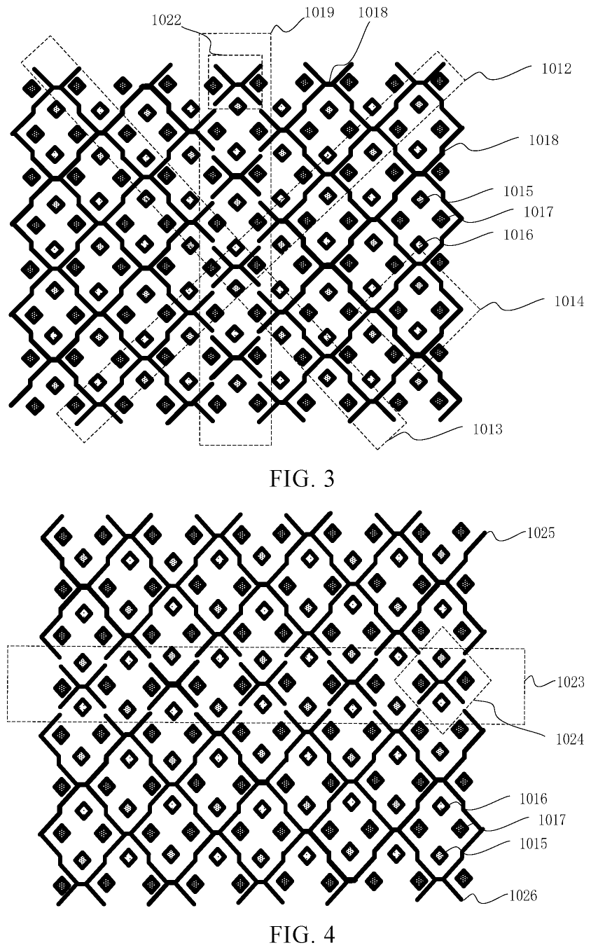

Please refer to FIGS. 3 and 4. FIG. 3 is a schematic structural view illustrating the first electrode layer of the touch substrate according to one embodiment of the present invention. FIG. 4 is a schematic structural view illustrating the second electrode layer of the touch substrate according to one embodiment of the present invention.

The first electrode 1011 comprises a plurality of first metal lines 1012 and a plurality of second metal lines 1013, and the first metal lines 1012 and the second metal lines 1013 are intersected to form a plurality of first grid units 1014; and/or the second electrode 1021 comprises a plurality of third metal lines 1025 and a plurality of fourth metal lines 1026, and the third metal lines 1025 and the fourth metal lines 1026 are intersected to form a plurality of second grid units 1023. A line width of the first metal line 1012 ranges from 0.1 um to 5 um, and/or a line width of the second metal line 1013 ranges from 0.1 um to 5 um, and/or a line width of the third metal line 1025 ranges from 0.1 um to 5 um, and/or a line width of the fourth metal line 1026 ranges from 0.1 um to 5 um. For example, the line width of the first metal line is 0.5 um, the line width of the second metal line is 0.5 um, the line width of the third metal line is 0.6 um, and the line width of the fourth metal line is 0.6 um. However, the present application is not intended to limit the line width of the first metal line, the line width of the second metal line, the line width of the third metal line, and the line width of the fourth metal line.

Please refer to FIG. 3.

In the present embodiment, the first grid unit 1014 has a diamond shape or a square shape. For example, when side lengths of the first metal lines 1012 in the first grid unit 1014 are equal, and an intersection angle of extension lines of the adjacent first metal lines is not 90°, the first grid unit 1014 has the diamond shape. The present application is not intended to limit the shape of the first grid unit 1014.

The present embodiment adopts a method of avoiding pixels. Four sub-pixels are enclosed in the first grid unit 1014. The four sub-pixels are a blue sub-pixel 1015, a red sub-pixel 1016, and two green sub-pixels 1017. The blue sub-pixel is located above the two green sub-pixels 1017, and the red sub-pixel 1016 is located below the two green sub-pixels 1017. Four sub-pixels are enclosed in the second grid unit 1023. The four sub-pixels are a blue sub-pixel, a red sub-pixel, and two green sub-pixels. The blue sub-pixel is located below the two green sub-pixels, and the red sub-pixel is located above the two green sub-pixels. The four sub-pixels are enclosed in the second grid unit 1023, wherein the first metal line 1012 comprises a plurality of bending portions 1018. In detail, the first metal line 1012 between the blue sub-pixel and the red sub-pixel adjacent to each other is perpendicular to a connection line between the blue sub-pixel and the red sub-pixel adjacent to each other. The bending portions 1018 are formed in the first metal line 1012 that is arranged linearly, and the bending portion 1018 is formed to avoid/bypass the pixels. The bending portions 1018 are arranged at end points of the grid unit and a middle point between two adjacent end points, so that the first metal line 1012 does not block light emission from the pixels.

The present embodiment adopts a method of avoiding pixels, four sub-pixels are enclosed in the first grid unit. The four sub-pixels are a blue sub-pixel, a red sub-pixel, and two green sub-pixels. The blue sub-pixel is arranged to the right of the two green sub-pixels, and the red sub-pixel is arranged to the left of the two green sub-pixels. Four sub-pixels are enclosed in the second grid unit. The four sub-pixels are a blue sub-pixel, a red sub-pixel, and two green sub-pixels. The blue sub-pixel is arranged to the left of the two green sub-pixels, and the red sub-pixel is arranged to the right of the two green sub-pixels. Four sub-pixels are enclosed in the second grid unit, wherein the first metal line comprises a plurality of bending portions. In detail, the first metal line between the blue sub-pixel and the red sub-pixel adjacent to each other is perpendicular to a connection line between the blue sub-pixel and the red sub-pixel adjacent to each other. The bending portions are formed in the first metal line that is arranged linearly, and the bending portion is formed to avoid/bypass the pixels, so that the first metal line will not block light emission from the pixels.

In the present embodiment, the first electrode 1011 is a driving electrode, and the second electrode 1021 is a sensing electrode; or the first electrode 1011 is a sensing electrode, and the second electrode 1021 is a driving electrode.

In the present embodiment, the touch substrate 10 further comprises a touch circuit 107. The first electrode 1011 is connected to the touch circuit 107 through a first electrode wire 108, and the second electrode 1021 is connected to the touch circuit 107 through a second electrode wire 109.

In the present embodiment, there are two first metal gaps 1019 between adjacent ones of the spaced first electrodes 1011, and the two first metal gaps 1019 keep the adjacent first electrodes 1011 insulated from each other. A first dummy pattern 1022 is formed between the two first metal gaps 1019. The first dummy pattern 1022 includes a fifth metal line and a sixth metal line that are arranged in an intersecting manner, and the fifth metal line and the sixth metal line are insulated from the first metal line and the second metal line. Further, the fifth metal line is located on an extension line of the first metal line, and the sixth metal line is located on an extension line of the second metal line. In the present embodiment, a ground capacitance of the first electrode 1011 can be changed by adjusting a width and an area of the first dummy pattern 1022, thereby changing the touch sensitivity of the touch substrate 10. For example, by increasing the area of the first dummy pattern 1022, the ground capacitance of the first electrode 1011 is increased, thereby increasing the touch sensitivity of the touch substrate 10. Similarly, there are two second metal gaps 1023 between adjacent ones of the spaced second electrodes 1021, and the two metal gaps 1023 keep adjacent second electrodes 1021 insulated from each other. A second dummy pattern 1024 is formed between the second metal gaps 1023. The second dummy pattern 1024 includes a seventh metal line and an eighth metal line that are arranged in an intersecting manner. The seventh metal line and the eighth metal line are insulated from the third metal line and the fourth metal line. Further, the seventh metal line is located on an extension line of the third metal line, and the eighth metal line is located on an extension line of the fourth metal line. In the present embodiment, a ground capacitance of the second electrode 1021 can be changed by adjusting a width and an area of the second dummy pattern 1024, thereby changing the touch sensitivity of the touch substrate 10.

The touch substrate 10 further comprises a display layer 104, a second insulating layer 105, and a third insulating layer 106. The second insulating layer 105 is disposed between the first electrode layer 101 and the display layer 104, and the third insulating layer 106 is disposed above the second electrode layer 102.

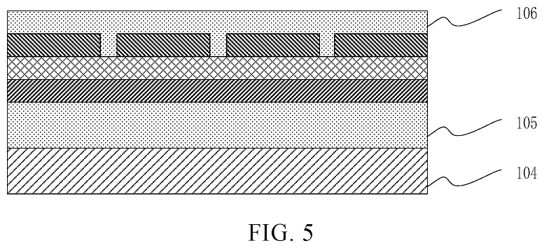

Please refer to FIGS. 2 and 5. FIG. 5 is a schematic structural view illustrating the touch substrate according to one embodiment of the present invention. The touch substrate 10 further comprises a display layer 104, a second insulating layer 105, and a third insulating layer 106. The second insulating layer 105 is disposed between the first electrode layer 101 and the display layer 104, and the third insulating layer 106 is disposed above the second electrode layer 102.

Although the touch substrate of the above embodiment only describes the above structure, it can be understood that, in addition to the above structure, the touch substrate of the present invention can also include any other necessary structures as required, such as a substrate, a buffer layer, and an interlayer dielectric layer (ILD); and the present invention is not limited in this regard.

In order to better implement the touch substrate 10 of the present invention, the present invention further provides a display panel on the basis of the touch substrate 10. The display panel comprises the touch substrate 10 in the foregoing embodiment. The display panel can be a liquid crystal display panel or an organic light-emitting diode (OLED) display panel. Specifically, the display panel of the present embodiment can be a flexible display panel or a rigid display panel.

In the display panel of the above embodiment, the display panel comprises the touch substrate 10. Compared to a conventional mutual-capacitive touch sensing element with a single-layer structure, the present embodiment adopts a layered structure. The first electrode layer 101 and the second electrode layer 102 are arranged in two different layers, thereby avoiding a conventional technical problem of uneven brightness at positions for connecting metal bridges, thus improving the display quality of the display panel.

In order to better implement the display panel in the embodiment of the present invention, the present invention further provides a display device on the basis of the display panel, and the display device comprises the display panel described in the above embodiment.

Compared to a conventional mutual-capacitive touch sensing element with a single-layer structure, the present invention adopts a layered structure. The first electrode layer 101 and the second electrode layer 102 in the display device of the above embodiment are arranged in two different layers, thereby avoiding a technical problem of uneven brightness in positions for connecting metal bridges, thus improving the display quality of the display panel.

In the above embodiments, the description of each embodiment has its own emphasis. For the parts that are not described in detail in one embodiment, please refer to the detailed descriptions of other embodiments above, and the detailed descriptions are not repeated here.

In practice, the above units or structures may be implemented as independent entities, or can be combined to become the same one or several entities. For the embodiments of the above units or structures, please refer to the foregoing embodiments, and a detailed description thereof is not repeated for brevity. For specific practice, please refer to the foregoing embodiments, and details thereof are not repeated herein.

For specific practice, please refer to the foregoing embodiments, and details thereof are not repeated herein.

The touch substrate, the display panel, and the display device of the present invention have been described in detail above. The embodiments of the present application have been described in detail above to illustrate the working principles of the present application. The above description is only provided for ease of understanding of the present invention and its main ideas. Those skilled in the art will be able to modify the embodiments and their applications. All such changes/modifications should be deemed to be within the protection scope of the present application. In conclusion, the content of the present disclosure should not be construed as limiting the present invention.

1. A touch substrate, comprising:
a touch region, wherein the touch substrate comprises a first electrode layer, a second electrode layer, and a first insulating layer, the first insulating layer is disposed between the first electrode layer and the second electrode layer, and the first electrode layer and the second electrode layer are disposed in the touch region.

2. The touch substrate according to claim 1, wherein the first electrode layer comprises at least two first electrodes arranged spaced apart along a first direction, the at least two first electrodes are insulated from each other, the second electrode layer comprises at least two second electrodes arranged spaced apart along a second direction, the at least two second electrodes are insulated from each other, and the first direction is unparallel to the second direction.

3. The touch substrate according to claim 2, wherein the first electrode comprises a plurality of first metal lines and a plurality of second metal lines, and the first metal lines and the second metal lines are intersected to form a plurality of first grid units; and/or the second electrode comprises a plurality of third metal lines and a plurality of fourth metal lines, and the third metal lines and the fourth metal lines are intersected to form a plurality of second grid units.

4. The touch substrate according to claim 3, wherein a line width of the first metal line ranges from 0.1 um to 5 um, and/or a line width of the second metal line ranges from 0.1 um to 5 um, and/or a line width of the third metal line ranges from 0.1 um to 5 um, and/or a line width of the fourth metal line ranges from 0.1 um to 5 um.

5. The touch substrate according to claim 3, wherein four sub-pixels are enclosed in the first grid unit, and four sub-pixels are enclosed in the second grid unit.

6. The touch substrate according to claim 3, wherein the first grid unit has a diamond shape or a square shape.

7. The touch substrate according to claim 3, wherein the first metal line comprises a plurality of bending portions.

8. The touch substrate according to claim 2, wherein the first electrode is a driving electrode, and the second electrode is a sensing electrode; or the first electrode is a sensing electrode, and the second electrode is a driving electrode.

9. The touch substrate according to claim 1, wherein the touch substrate further comprises a touch circuit, the first electrode is connected to the touch circuit through a first electrode wire, and the second electrode is connected to the touch circuit through a second electrode wire.

10. The touch substrate according to claim 1, wherein the touch substrate further comprises a display layer, a second insulating layer, and a third insulating layer, the second insulating layer is disposed between the first electrode layer and the display layer, and the third insulating layer is disposed over the second electrode layer.

11. A display panel, comprising:
a touch substrate comprising a touch region, wherein the touch substrate comprises a first electrode layer, a second electrode layer, and a first insulating layer, the first insulating layer is disposed between the first electrode layer and the second electrode layer, and the first electrode layer and the second electrode layer are disposed in the touch region.

12. The display panel according to claim 11, wherein the display panel is a liquid crystal display (LCD) panel or an organic light-emitting diode (OLED) display panel.

13. The display panel according to claim 11, wherein the first electrode layer comprises at least two first electrodes arranged spaced apart along a first direction, the at least two first electrodes are insulated from each other, the second electrode layer comprises at least two second electrodes arranged spaced apart along a second direction, the at least two second electrodes are insulated from each other, and the first direction is unparallel to the second direction.

14. The display panel according to claim 13, wherein the first electrode comprises a plurality of first metal lines and a plurality of second metal lines, and the first metal lines and the second metal lines are intersected to form a plurality of first grid units; and/or the second electrode comprises a plurality of third metal lines and a plurality of fourth metal lines, and the third metal lines and the fourth metal lines are intersected to form a plurality of second grid units.

15. The display panel according to claim 14, wherein a line width of the first metal line ranges from 0.1 um to 5 um, and/or a line width of the second metal line ranges from 0.1 um to 5 um, and/or a line width of the third metal line ranges from 0.1 um to 5 um, and/or a line width of the fourth metal line ranges from 0.1 um to 5 um.

16. The display panel according to claim 14, wherein four sub-pixels are enclosed in the first grid unit, and four sub-pixels are enclosed in the second grid unit.

17. The display panel according to claim 14, wherein the first grid unit has a diamond shape or a square shape.

18. The display panel according to claim 14, wherein the first metal wire comprises a plurality of bending portions.

19. The display panel according to claim 13, wherein the first electrode is a driving electrode, and the second electrode is a sensing electrode; or the first electrode is a sensing electrode, and the second electrode is a driving electrode.

20. A display device, comprising the display panel of claim 11.
